(19) United States
(12) Patent Application Publication
(10) Pub. No.: US 2018/0079950 A1
(43) Pub. Date: Mar. 22, 2018

(54) DEGRADABLE BALL SEALERS WITH IMPROVED SOLUBILITY CHARACTERISTICS

(71) Applicant: Fairmount Santrol Inc., Chesterland, OH (US)

(72) Inventors: Huaxiang Yang, Sugar Land, TX (US); Kanth V. Josyula, Sugar Land, TX (US); Vinay R. Mehta, Richmond, TX (US); An Nguyen, Sugar Land, TX (US)

(21) Appl. No.: 15/708,957

(22) Filed: Sep. 19, 2017

Related U.S. Application Data
(60) Provisional application No. 62/396,960, filed on Sep. 20, 2016.

(51) Int. Cl. C09K 8/50; C08L 29/04; C08L 31/04; C08L 67/04; E21B 33/13

(52) U.S. Cl. CPC C09K 8/50; C08L 29/04; C08L 31/04; E21B 43/25; E21B 33/13; C08L 2205/025; C08L 2205/03; C08L 67/04

(57) ABSTRACT

Perforation ball sealers with improved solubility characteristics are made from a vinyl alcohol/vinyl acetate copolymer (PVOH) having a degree of hydrolysis of ˜50% to 84%, or from a molding grade ethylene/vinyl alcohol copolymer (EVOH) containing 24-48 mol % ethylene and having a degree of hydrolysis of 85 to 99%, or from a blend of both.

### CROSS-REFERENCE TO RELATED APPLICATION

This application claims priority to and all benefit of U.S. Provisional Patent Application Ser. No. 62/396,960, filed on Sep. 20, 2016, titled DEGRADABLE BALL SEALERS WITH IMPROVED SOLUBILITY CHARACTERISTICS, the entire disclosure of which is fully incorporated herein by reference.

### BACKGROUND

During the life of an oil or gas well, the subterranean formation of the well may be treated at the time of initial stimulation as well as from time to time by pumping a suitable treatment fluid into the well to aid in well stimulation, thereby creating highly conductive pathways for increased production. Examples of such treatments include fracturing and acidizing. When the well penetrates multiple strata having different permeabilities, much of this treatment fluid can be lost by flowing through strata with higher permeabilities. To prevent this from happening, perforation ball sealers can also be pumped into the well, either before the well treatment or together with the treatment fluid. Because more treatment fluid flows through strata with higher permeabilities, the ball sealers preferentially seal well bore perforations that feed higher permeability strata. As a result, the treatment fluid tends to distribute more uniformly over the subterranean formation as a whole.

Acidizing is stimulation technique that uses acidic fluids to dissolve part of the downhole formation. Acids are also used to clean old drilling fluids and scales during well stimulation. This practice is referred to in the industry as matrix acidizing. Acid enlarges existing channels or makes new ones through etching of the formation. Today, acidizing is widely used in limestone and dolomitic formations. The primary purpose of the ball sealers is to temporarily shut the perforations in selected zones in order to divert the treatment fluid to the desired zones where stimulation or refracturing must effectively occur without fluid loss to the selected zone or stimulation pressure loss in the desired zone.

Early ball sealers were made from permanent materials such as nylon, phenolics and rubber coated metal. As a result, some form of mechanical processing was needed for ball sealer removal once well treatment was completed.

Later, beginning in the late 1980's, degradable ball sealers made from polymers and copolymers of lactic acid esters were introduced. See, for example, U.S. Pat. No. 4,716,964 to Erbstrosser et al., the disclosure of which is incorporated herein by reference. Since these polymers are slowly soluble in acidified water, mechanical removal was no longer necessary.

At the present time, most commercially available degradable ball sealers are believed to be made from lactic acid ester polymers and copolymers of the type shown in the above-noted Erbstrosser et al. patent. In industry, these materials are commonly referred to as polylactic acids (or PLA) even though, technically, these materials are esters, not acids.

Numerous other slowly water soluble materials have also been proposed for use in making degradable ball sealers. Examples include polyethylene oxides (PEO), naturally occurring polymers such as collagen and chitosan, polyvinyl alcohol polymers (PVOH), ethylene vinyl alcohol copolymers (EVOH), and the like.

These materials including PLA exhibit different dissolution rates, i.e., they dissolve at different rates of speed depending on the conditions of temperature and pH encountered downhole. This provides the advantage of customization, i.e., it enables the most appropriate ball sealer to be selected for use in each particular subterranean formation. At the same time, this also creates a certain disadvantage in that a variety of different polymer formulations are needed to satisfy all customer needs.

Oil and gas bearing subterranean formations where ball sealers are found can exhibit widely differing downhole conditions of temperatures and pH. Some exhibit low downhole temperatures, e.g., ˜75° F. to 200° F. (˜24° C. to ˜93° C.). Others exhibit medium downhole temperatures, e.g., ˜150° F. to 250° F. (˜66° C. to ˜121° C.). And still others exhibit high downhole temperatures, e.g., ˜200° F. to 350° F. (˜93° C. to ˜177° C.) and higher.

In addition, depending on the naturally occurring ground water found there as well as the liquids pumped downhole either before or together with the ball sealers, each of these formations can also exhibit widely differing pH conditions. Thus, some formations exhibit alkaline conditions (e.g., pH of 9-11), while others exhibit neutral conditions (e.g., pH of ˜7). Still others exhibit highly acidic conditions (e.g., pH of ˜0 to 1 or even −1 to 0) from being treated with strong acids, e.g., 15% HCl, during acidizing or matrix acidizing. Potentially, therefore, nine different sets of downhole conditions can be found where ball sealers are present in oil and gas bearing subterranean formations—low, medium or high temperature at alkaline, neutral or the highly acidic pH associated with acidizing treatments.

Unfortunately, practically all of the materials currently being used for making degradable ball sealers are effective at only at one or perhaps two of these different sets of conditions. This means that, as a practical matter, manufacturers must use a variety of different polymers to satisfy all potential customer needs. Similarly, suppliers must keep in stock an inventory of as many as 5, 6, 7 or even 8 different ball sealers.

To make matters worse, many slowly water soluble polymer resins are difficult to mold into spheres. Others are incapable of forming effective seals over extended periods of time, either because they are too rigid or because they exhibit insufficient compressive strength. Still others swell when contacted with moisture, which can cause storage stability problems before use as well as operational problems such as ball injector jamming and reduced seating efficiency during use. Still others require acid treatments for removal.

### SUMMARY

In accordance with a first aspect of this invention, we have found that slowly water soluble ball sealers which are effective at all downhole conditions of temperature and pH levels, other than high temperature and the highly acidic pH conditions associated with acidizing treatments, can be made from a first set of just two different polymers used either singly or in combination, these two different polymers being (a) a molding grade vinyl alcohol/vinyl acetate copolymer having a degree of hydrolysis of ˜50% to 84% and (b) a vinyl alcohol/vinyl acetate copolymer having a melting point of 200° C. to 240° C., a melt flow index (MFI) at 220° C. of 10-15 g/10 minute and a viscosity at 220° C. of 150-1500 Pa-sec.

In particular, we have found in accordance with this first aspect that the above molding grade vinyl alcohol/vinyl acetate copolymer (“PVOH”) having a degree of hydrolysis of ˜50% to 84%, when used under low temperature conditions, not only exhibits useful dissolution rates regardless of pH, but in addition also exhibits the additional functional properties that are needed for a polymer to form a commercially-effective ball sealer, these additional functional features including (a) being easy to mold, (b) crush strength, (c) sealing effectiveness, (d) swelling resistance, and (e) being easily dissolved in treatment fluids.

In addition, we have further found in accordance with this first aspect that vinyl alcohol/vinyl acetate copolymers having melting points of 200° C. to 240° C., melt flow indexes (MFI) at 220° C. of 10-15 g/10 minute and viscosities at 220° C. of 150-1500 Pa-sec., when used alone under high downhole temperature conditions, not only exhibit useful dissolution rates at alkaline and neutral pH conditions, but in addition also exhibit the additional functional properties that are needed for a polymer to form a commercially-effective ball sealer, these additional functional features including (a) being easy to mold, (b) crush strength, (c) sealing effectiveness, (d) swelling resistance, and (e) being easily dissolved in treatment fluids.

Thus, it is possible in accordance with this first aspect of the invention to provide a full complement of ball sealers capable of operating at all different downhole conditions of temperature and pH level, other than conditions of high temperature and the highly acidic pH conditions associated with acidizing treatments, with just two different polymers. This greatly simplifies the task of making and selling ball sealers meeting all potential customer needs, since only two polymers are necessary for satisfying all of these different needs.

Thus, in accordance with this first aspect, this invention provides a first system of ball sealers capable of operating at all different downhole conditions of temperature and pH level, other than conditions of high temperature and the highly acidic pH conditions associated with acidizing treatments, this first system comprising the combination of two or more ball sealers, wherein each ball sealer in this first system is made from a first slowly water soluble polymer, a second slowly water soluble polymer, or a blend of these two slowly water soluble polymers, wherein the first slowly water soluble polymer comprises a molding grade vinyl alcohol/vinyl acetate copolymer (PVOH) having a degree of hydrolysis of ˜50% to 84%, and wherein the second slowly water soluble polymer comprises a vinyl alcohol/vinyl acetate copolymer (PVOH) having a melting point of 200° C. to 240° C., a melt flow index (MFI) at 220° C. of 10-15 g/10 minute and a viscosity at 220° C. of 150-1500 Pa-sec.

In addition, this first aspect also provides a process for sealing perforations in a well bore penetrating a subterranean formation, the process comprising charging the above ball sealers into the well bore.

In accordance with a second aspect of this invention, we have found that slowly water soluble ball sealers which are effective at all downhole conditions of temperature and pH levels, other than high temperature and the highly acidic pH conditions associated with acidizing treatments, can be made from a different, second set of just two polymers used either singly or in combination, these two polymers being (a) the same molding grade vinyl alcohol/vinyl acetate copolymer mentioned above (i.e., having a degree of hydrolysis of ˜50% to 84%) and (b) a molding grade ethylene/vinyl alcohol copolymers (“EVOH”) containing 24-48 mol % ethylene and having a degree of hydrolysis of at least 85 mol %.

That is to say, in the same way as the PVOH polymer (b) mentioned above in connection with the first aspect of this invention, we have found in accordance with this second aspect of the invention that this EVOH polymer, in addition to exhibiting essentially the same additional functional features mentioned above including (a) being easy to mold, (b) crush strength, (c) sealing effectiveness, (d) swelling resistance, and (e) being easily dissolved by treatment fluids, also exhibits useful dissolution rates when used at high downhole temperatures and alkaline and neutral pH conditions.

Thus, in accordance with this second aspect, this invention provides a system of ball sealers capable of operating at all different downhole conditions of temperature and pH level, other than conditions of high temperature and the highly acidic pH conditions associated with acidizing treatments, this system comprising the combination of two or more ball sealers, wherein each ball sealer in this system is made from a first slowly water soluble polymer, a second slowly water soluble polymer, or a blend of these two slowly water soluble polymers, wherein the first slowly water soluble polymer comprises a molding grade vinyl alcohol/vinyl acetate copolymer (PVOH) having a degree of hydrolysis of ˜50% to 84%, and wherein the second slowly water soluble polymer comprises a molding grade ethylene/vinyl alcohol copolymers (“EVOH”) containing 24-48 mol % ethylene and having a degree of hydrolysis of at least 85 mol %.

In addition, this second aspect also provides a process for sealing perforations in a well bore penetrating a subterranean formation, the process comprising charging these ball sealers into the well bore.

In accordance with a third aspect of this invention, we have found that blends of 90 to 40 wt. % of a vinyl alcohol/vinyl acetate copolymer (PVOH) having a degree of hydrolysis of 85% or more and 10 to 60 wt. % of a fully amorphous grade polylactic acid ester (PLA) polymer can be used to provide ball sealers for use at medium downhole temperatures of 150° F. (˜66° C.) to 250° F. (˜121° C.), regardless of pH.

That is to say, we have found that these blends, in addition to exhibiting essentially the same additional functional features mentioned above including (a) being easy to mold, (b) crush strength, (c) sealing effectiveness, (d) swelling resistance, and (e) being easily dissolved by treatment fluids, also exhibit useful dissolution rates at medium downhole temperatures of 150° F. (˜66° C.) to 250° F. (˜121° C.), regardless of pH.

Thus, in accordance with this third aspect, this invention provides ball sealers capable of operating at medium downhole temperatures of 150° F. (˜66° C.) to 250° F. (˜121° C.), regardless of pH, wherein these ball sealers are made from blends of 90 to 40 wt. % of a vinyl alcohol/vinyl acetate copolymer (PVOH) having a degree of hydrolysis of 85% or more and 10 to 60 wt. % of a fully amorphous grade polylactic acid ester (PLA) polymer

In addition, this third aspect also provides a process for sealing perforations in a well bore penetrating a subterranean formation, the process comprising charging these ball sealers into the well bore.

Finally, in accordance with a fourth aspect of this invention, we have further found that molding grade polylactic acid ester polymers (PLA), as well as condensation polyesters based on hydroxy-substituted C₁-C₈ carboxylic acids, in addition to exhibiting essentially the same additional functional features mentioned above including (a) being easy to mold, (b) crush strength, (c) sealing effectiveness, (d) swelling resistance, and (e) being easily dissolved by treatment fluids, also exhibit useful dissolution rates when used under high temperature conditions at the highly acidic pH levels associated with acidizing treatments.

Thus, in accordance with this fourth aspect, this invention provides ball sealers capable of operating at high downhole temperatures at the highly acidic pH conditions associated with acidizing treatments, wherein these ball sealers are made from either a molding grade polylactic acid ester polymer (PLA) or a polyester polymer based on a hydroxy-substituted C₁-C₈ carboxylic acid.

In addition, this fourth aspect also provides a process for sealing perforations in a well bore penetrating a subterranean formation, the process comprising charging these ball sealers into the well bore.

### DETAILED DESCRIPTION

### Desirable Dissolution Rates

As appreciated in the ball sealer art, the particular ball sealer used in a particular well is selected so that, under the particular conditions of temperature and pH that will be encountered, it dissolves at a useful dissolution rate, i.e., at a rate which is slow enough to allow the treatment process to be completed but fast enough so that it dissolves promptly after the treatment process is done.

In accordance with this invention, ball sealers which exhibit useful dissolution rates under all potential downhole conditions of temperature and pH are made from a few selected polymers, as further described below. By this, we do not mean to say that every polymer used in our invention will dissolve at a useful dissolution rate under every set of temperature and pH conditions that might be encountered downhole. Rather, we mean that ball sealers which exhibit useful dissolution rates under all of these different sets of conditions can be made by appropriate selection of which of these relatively few particular polymers to use, whether singly or in combination.

### pH of Subterranean Formation

In the description below, we identify ball sealers which are intended for processing subterranean formations existing at different pH conditions, in particular alkaline and neutral pH conditions as well as the highly acidic pH conditions associated with acidizing treatments. In addition, in this description, we associate alkaline conditions with a pH of 9-11, neutral conditions with a pH of ˜7, and the highly acidic pH conditions associated with acidizing treatments with a pH of −1 to 1.0.

It should be understood that we have chosen these particular pH conditions for testing purposes only. That is to say, these particular pH conditions are useful for carrying out analytical tests to demonstrate that particular ball sealers are useful under alkaline, neutral or the highly acidic pH conditions associated with acidizing treatments. We do not mean to say that the ball sealers we identify for use at these different pH conditions are only useful, or intended only for use at, these particular pH levels of 9-11, ˜7, and −1 to 1.0.

As well understood in the art, the particular pH conditions exhibited by a subterranean formation where ball sealers are found can be due to a variety of different factors including the pH of the naturally occurring ground water found in the formation, the pH of the carrier liquid used to charge the ball sealers downhole, and the pH of well treatment fluids that were charged into the formation before the ball sealers were charged downhole. So, when we say that a particular ball sealer is used for treating a subterranean formation exhibiting alkaline, neutral or the highly acidic pH conditions associated with acidizing treatments, what we mean is that the pH exhibited by subterranean formation being processed as a whole is predominately alkaline, neutral or highly acidic in keeping with the conventional meanings of these terms as used in this art. In practice, this typically means that a well will be regarded as exhibiting a neutral pH if the predominant pH exhibited by the aqueous liquids anticipated to be found in its different strata ranges between about 6 and about 8. Wells anticipated to have aqueous liquids with higher pH levels will be regarded as exhibiting an alkaline pH. Meanwhile, wells anticipated to have aqueous liquids with lower pH levels will generally be regarded as exhibiting the highly acidic pH conditions associated with acidizing treatments, since wells exhibiting moderately low pH levels, e.g., pH of 3-4, are rare if they exist at all.

### Physical Form

The inventive ball sealers have a conventional physical form. That is to say, they are spheres having diameters normally used in the oil and gas industry, which typically range from as much as 5 inches to as little as ½ inch. Examples of typical diameters are ⅞ inch, 1 inch and 1¼ inch.

### Molding Grade

Some of the polymers mentioned below are described as molding grade polymers. In this context, “molding grade” means that the polymer has been formulated in a manner which will allow it to be injection molded with reasonable ease, i.e., in a commercially feasible way. In this regard, it is well known in the plastics industry that a number of different factors affect the ability of a polymer resin to be easily molded including such things as molecular weight, type and amount of crosslinking agents, if any, type and amount of plasticizers, and so forth. See, Bryce, Douglass, Plastics Injection Molding Process Fundamentals SME, ISBN-13: 978-0872634725.

It is also well known that many different types and grades of particular polymers including PVOH, EVOH, PLA and PEO polymers are commercially available. That being the case, skilled polymer chemists should have no difficulty in selecting particular polymers for use in this invention which are molding grade.

### PVOH Systems

In accordance with a first aspect of this invention, we have found that polymer systems based on a first set of two different slowly water-soluble polymers, both being polyvinyl alcohol (PVOH) polymers, can be used to make ball sealers exhibiting useful dissolution rates in all downhole conditions of temperature and pH, except for high temperature and the highly acidic pH conditions associated with acidizing treatments. That is to say, we have found that these slowly water soluble PVOH polymers, in addition to exhibiting dissolution rates which enable them to function at all of these different downhole conditions, also exhibit the additional functional properties needed for a polymer to make an effective commercial ball sealer including (a) being easy to mold, (b) crush strength, (c) sealing effectiveness, (d) swelling resistance, and (e) being easily dissolved by treatment fluids.

Most commercially available PVOH polymers are actually copolymers of vinyl alcohol and vinyl acetate. Normally, they are made by saponifying polyvinyl acetate homopolymers. The extent to which the pendant acetate moieties of these homopolymers are converted into pendant hydroxyl groups is referred to as the degree of hydrolysis (DH) of the polymer. Both degree of hydrolysis as well as molecular weight contribute to the water solubility of these polymers.

In accordance with this first aspect of the invention, we have found that molding grade polyvinyl alcohol (PVOH) polymers having a degree of hydrolysis of about 50 to 84%, when used alone, in addition to exhibiting the additional functional features mentioned above, exhibit useful dissolution rates at low downhole temperatures (i.e., at temperatures ranging from 75° F. (˜24° C.) to 200° F. (˜93° C.) at alkaline, neutral and the highly acidic pH conditions associated with acidizing treatments.

Molding grade PVOH polymers having a degree of hydrolysis of less than about 50% dissolve too slowly, while those exhibiting a degree of hydrolysis of more than 84% are generally too brittle to mold easily, even if they contain significant amounts of processing aids such as plasticizers and the like.

Especially preferred are those which exhibit a degree of hydrolysis of 60 to 80%, 65 to 78% or even 70 to 75%. Of these, those that exhibit low molecular weights, as reflected by a viscosity of 2.5 to 10 mPa s, 3.5 to 6 mPa s, or even 4.0 to 5.0 mPa s, when measured in a 4% aqueous solution at 20° C., are of special interest.

The ability of these PVOH polymers to exhibit useful dissolution rates at low downhole temperatures under all pH conditions is illustrated in the following Example 1, which shows that a molding grade PVOH polymer having a degree of hydrolysis of 70-75 exhibited dissolution rates between about 2 and 24 hours at temperature ranged from 75° F. (˜24° C.) to 200° F. (˜93° C.) at alkaline, neutral and highly acidic pH conditions. Although these dissolution rates differed from one another depending on the particular conditions of temperature and pH encountered, nonetheless all were useful in the sense that the target dissolution was reached within a reasonable period of time, 2 to 24 hours. This suggests that, regardless of pH, ball sealers made from this particular polymer will be effective for use in subterranean formations existing at these temperatures. That is to say, this suggests that, for subterranean formations in which the temperatures of the different strata range between 75° F. (˜24° C.) and 200° F. (˜93° C.), these ball sealers will enable well treatments to be completed within a reasonable period time, followed by prompt removal of the ball sealer after treatment has been completed, whether such subterranean formations exhibit alkaline, neutral or the highly acidic pH's associated with acidizing treatments.

In further accordance with this first aspect of the invention, we have also found that polyvinyl alcohol (PVOH) polymers having a melting point of 200° C. to 240° C., a melt flow index (MFI) at 220° C. of 10-15 g/10 minute and a viscosity at 220° C. of 150-1500 Pa-sec, when used alone, in addition to exhibiting the additional functional features mentioned above, exhibit useful dissolution rates at high downhole temperatures, i.e., at temperatures ranging from 200° F. (˜93° C.) to 300° F. (˜149° C.), at alkaline and neutral pH conditions.

This is shown in the following Example 2, which shows that a PVOH polymer having a melting point of 200° C. to 240° C., a melt flow index (MFI) at 220° C. of 10 to 15 g/10 minutes and a viscosity at 220° C. of 150-1500 Pa-sec, exhibited dissolution rates between about 2 and 5 hours within the high temperatures range of 200° F. (˜93° C.) and 300° F. (˜149° C.) in neutral (pH ˜7) and alkaline (pH ˜11) conditions. This suggests that, for subterranean formations exhibiting these conditions of pH and temperature, ball sealers made from this particular polymer will also enable well treatments to be completed in reasonable amounts of time.

In still further accordance with this first aspect of the invention, we believe that blends of these two polymers, will not only exhibit the additional features needed for a polymer to form commercially effective ball sealers as mentioned above, but in addition will also exhibit useful dissolution rates at low temperatures ranging from 75° F. (˜24° C.) to 200° F. (˜93° C.) as well as at medium temperatures ranging from 150° F. (˜66° C.) to 250° F. (˜121° C.) at all pH conditions, i.e., at alkaline, neutral and the highly acidic pH conditions associated with acidizing treatments. That is to say, for each particular blend of these two different polymers, depending on the amounts of each polymer included in the blend, we believe the blend not only will exhibit the additional features mentioned above but, in addition, will exhibit useful dissolution rates at multiple combinations of different sets of conditions of temperature and pH, thereby enabling ball sealers made from each blend to be used at many different sets of these conditions.

Thus, this first aspect of the invention provides a first system of ball sealers capable of operating at all different downhole conditions of temperature and pH level, other than conditions of high temperature and the highly acidic pH conditions with acidizing treatments, this first system comprising the combination of the above two PVOH polymers.

### Additional Comonomers

In the description below, we identify a number of different polymers and copolymers which are useful in carrying out this invention. Unless otherwise indicated, it will be understood that these polymers and copolymers can include additional unspecified comonomers so long as the amount of these comonomers does not adversely affect the performance of the polymer or copolymer in any significant way. Normally, the amount of these unspecified copolymers will be no greater than 30 mol %. More typically, the amount of these unspecified copolymers will be no greater than 25 mol %, no greater than 20 mol %, no greater than 15 mol %, no greater than 10 mol %, no greater than 5 mol %, no greater than 2 mol %, or even no greater than 1 mol %.

### PVOH-EVOH Systems

In accordance with a second aspect of this invention, we have found that polymer systems based on a second, different set of two slowly water soluble polymers, one being a PVOH polymer and the other being an EVOH polymer, can be also be used to make ball sealers exhibiting useful dissolution rates in all downhole conditions of temperature and pH, except for high temperature and the highly acidic pH conditions associated with acidizing treatments. That is to say, we have found that these two slowly water soluble polymers, in addition to exhibiting dissolution rates which enable them to function at all of these different downhole conditions, also exhibit the additional functional properties needed for a polymer to make an effective commercial ball sealer including (a) being easy to mold, (b) crush strength, (c) sealing effectiveness, (d) swelling resistance, and (e) being easily dissolved by treatment fluids.

The PVOH polymer used in this second aspect of the invention is the same molding grade PVOH polymer used in the first aspect of this invention, i.e., a molding grade polyvinyl alcohol (PVOH) polymer having a degree of hydrolysis of about 50 to 84%. As indicated above and shown in the following Example 1, this PVOH polymer when used alone, in addition to exhibiting the additional functional features mentioned above, also exhibit useful dissolution rates at low downhole temperatures (i.e., at temperatures ranging from 75° F. (˜24° C.) to 200° F. (˜93° C.) at alkaline, neutral and the highly acidic pH conditions associated with acidizing treatments.

In accordance with this second aspect of the invention, we have found that certain EVOH copolymers, i.e., copolymers of ethylene and vinyl alcohol, when used alone, in addition to exhibiting the additional functional properties needed for a polymer to form commercially effective ball sealers including (a) being easy to mold, (b) crush strength, (c) sealing effectiveness, (d) swelling resistance, and (e) being easily dissolved by treatment fluids, also exhibit useful dissolution rates at high downhole temperatures, i.e., at temperatures ranging from 200° F. (˜93° C.) to 350° F. (˜177° C.), at alkaline and neutral pH's. In other words, we have found that these EVOH polymers act in essentially the same way as the PVOH polymers (b) of the first aspect of this invention in terms of exhibiting useful dissolution rates at high downhole temperatures at alkaline and neutral pH's.

These EVOH copolymers can be described as copolymers of ethylene and vinyl alcohol which exhibit a melting point of 180° C. to 215° C. and a specific gravity of 0.5 to 1.34 g/cc. Of these, EVOH copolymers which exhibit a melting point of 180° C. to 200° C., a melt flow index (MFI) at 190° C. of 15-35 g/10 minute and a viscosity at 190° C. of 90-900 Pa-sec are interesting, as are those which exhibit a melting point of 210° C. to 215° C., a melt flow index (MFI) at 230° C. of 70-90 g/10 min, and a specific gravity of 1.25-1.35 g/cc.

Particularly interesting EVOH copolymers are those which contain 24-48 mol % ethylene and which have a degree of hydrolysis of at least 85 mol %. Those in which hydrolysis is essentially complete, e.g., those having a degree of hydrolysis of at least 95%, preferably at least 97% or even at least 98%, are even more interesting.

In this regard, EVOH polymers are normally made in much the same way as PVOH polymers (although EVOH polymers are copolymers) in that a polymer containing polymerized vinyl acetate is first formed, which is then saponified to convert its vinyl acetate groups to vinyl alcohol groups. So, when we refer to an EVOH copolymer having a degree of hydrolysis of say 85%, for example, what we mean is a copolymer of ethylene and vinyl acetate in which 85% of the copolymerized vinyl acetate moieties have been converted to vinyl alcohol moieties.

The ability of these EVOH polymer to exhibit useful dissolution rates at high downhole temperatures at alkaline and neutral pH's is shown in the following Example 3 in which the particular EVOH polymer described there exhibited dissolution rates between about 2 and 5 hours within the high temperatures range of 200° F. (˜93° C.) and 300° F. (˜149° C.) in neutral (pH ˜7) and alkaline (pH ˜11) conditions. This suggests that, for subterranean formations exhibiting these conditions of pH and temperature, ball sealers made from this particular polymer will also enable well treatments to be completed in reasonable amounts of time.

In further accordance with this second aspect of the invention, we have also found that blends of these two polymers, not only exhibit the additional features needed for a polymer to form commercially effective ball sealers including (a) being easy to mold, (b) crush strength, (c) sealing effectiveness, (d) swelling resistance, and (e) being easily dissolved in treatment fluids, but in addition also exhibit useful dissolution rates at low temperatures ranging from 75° F. (˜24° C.) to 200° F. (˜93° C.) as well as at medium temperatures ranging from 150° F. (˜66° C.) to 250° F. (˜121° C.) at all pH conditions, i.e., at alkaline, neutral and the highly acidic pH conditions associated with acidizing treatments.

For example, as shown in the following Example 4, a blend comprising 90 wt. % of the PVOH polymer mentioned above (molding grade PVOH polymer with a DH of 70-75) and 10 wt % of the EVOH polymer mentioned above, in addition to exhibiting the additional functional features mentioned above, exhibited dissolution rates ranging between 3 and 22 hours at alkaline, neutral and highly acidic pH conditions when used at the low temperature range of 75° F. (˜24° C.) to 200° F. (˜93° C.). However, as further shown in Example 2, under neutral conditions at 75° F. (˜24° C.), the dissolution rate took longer than 24 hours, while at 200° F. (˜93° C.) and acidic conditions the dissolution rate was less than 2 hours. This suggests that this particular blend would likely not be appropriate for subterranean formations existing at these particular conditions and that other polymers should be used. However, for all other combinations of pH and within the low temperature range of 75° F. (˜24° C.) to 200° F. (˜93° C.), this blend would likely be appropriate.

Another example of a suitable PVOH/EVOH blend is shown in the following Example 5 in which a blend comprising 60 wt. % of the PVOH polymer mentioned above and 40 wt % of the EVOH polymer mentioned above was used under medium temperature conditions of 150° F. (˜66° C.) to 250° F. (˜121° C.). As shown there, this blend exhibited useful dissolution rates of 2 to 24 hours under all pH conditions and all temperatures ranging between 175° F. (˜79° C.) and 250° F. (˜121° C.). However, at the low end of this temperature range, i.e., at 150° F. (˜66° C.), the dissolution rates exhibited by this blend were significantly longer than 24 hours in neutral and alkaline conditions. However, under the highly acidic conditions associated with acidizing treatments, the dissolution rate exhibited by this polymer was 3 hours. This suggests that, while this particular blend might not be appropriate for subterranean formations existing at 150° F. (˜66° C.) under neutral or alkaline conditions, it would be appropriate for subterranean formations existing at all other conditions of pH and temperatures of 150° F. (˜66° C.) to 250° F. (˜121° C.).

Thus, this invention provides a second system of ball sealers capable of operating at all different downhole conditions of temperature and pH level, other than conditions of high temperature and the highly acidic pH conditions associated with acidizing treatments, this second system comprising the combination of the above molding grade PVOH polymer having a degree of hydrolysis of about 50 to 84% and the above EVOH polymer.

### PVOH-PLA Systems

In accordance with a third aspect of this invention, blends of 90 to 40 wt. % of a vinyl alcohol/vinyl acetate copolymer (PVOH) having a degree of hydrolysis of 85% or more and 10 to 60 wt. % of a fully amorphous grade polylactic acid ester (PLA) polymer are used to provide ball sealers for use at medium downhole temperatures of 150° F. (˜66° C.) to 250° F. (˜121° C.), regardless of pH. Blends containing 75 to 50 wt. % of the PVOH polymer and 25 to 50 wt. % of the PLA polymer are more interesting, while blends containing 65 to 55 wt. % of the PVOH polymer and 35 to 45 wt. % of the PLA polymer are even more interesting,

PVOH polymers having degrees of hydrolysis of 85% or more tend to be brittle and are therefore difficult to mold. In accordance with this aspect of the invention, we have found that blends of these PVOH polymers with non-crystalline PLA polymers (i.e., PLA polymers lacking stereo-specificity due to a higher content of D-isomers) not only can be easily injection molded into ball sealers of appropriate size but, in addition, also exhibit useful dissolution rates when used at medium downhole temperatures, at alkaline, neutral and acidic pH's. In addition, they also exhibit the other additional functional features needed for commercial ball sealer use including (b) crush strength, (c) sealing effectiveness, (d) swelling resistance, and (e) being easily dissolved by treatment fluids.

For example, as shown in the following Example 6, we have found that a blends of 60 wt. % vinyl alcohol/vinyl acetate copolymers (PVOH) having a degree of hydrolysis of 85% or more and 40 wt. % of a fully amorphous grade polylactic acid ester (PLA) polymer will provide dissolution rates ranging between 2 and 4 hours at temperature ranges of 150° F. (˜66° C.) to 250° F. (˜121° C.), regardless of pH. This suggests that ball sealers made from these polymer blends would also be generally useful for processing subterranean formations existing at these temperature ranges, regardless of pH.

### High Temperature Highly Acidic Systems

In accordance with a fourth aspect of this invention, we have further found that a number of different types of slowly water soluble polymers including molding grade polylactic acid ester polymers (PLA) as well as condensation polyesters based on hydroxy-substituted C₁-C₈ carboxylic acids, in addition to exhibiting essentially the same additional functional features mentioned above including (a) being easy to mold, (b) crush strength, (c) sealing effectiveness, (d) swelling resistance, and (e) being easily dissolved by treatment fluids, also exhibit useful dissolution rates when used under high temperature conditions at the highly acidic pH levels typically used during acidizing treatments of limestone and dolomitic formations.

The particular molding grade polylactic acid ester polymers (PLA) that can be used for this purpose can be described as having a D-isomer content of 1-4% and a relative viscosity of 2-4. Similarly, the particular polyester polymers that can be used for this purpose can be described as condensation polymers and copolymers of hydroxy-substituted C₁-C₁₀ carboxylic acids, examples of which include polyhydroxybutyrate (PHB) and polyhydroxyhexanoate (PHH). Copolymers of these C₁-C₁₀ carboxylic acids, and especially copolymers of hydroxybutyrate and hydroxyhexanoate, are preferred. Of these polymers and copolymers, those having weight average molecular weights of 400,000 to 900,000, melting points of 130° C. to 160° C. and specific gravities of 1.0 to 1.3 g/cc are especially interesting.

For example, as shown in the following Examples 7 and 8, we have found that under the highly acidic pH conditions associated with acidizing treatments, both types of these polymers exhibit dissolution rates of between 8 and 4 hours at temperatures of 250° F. (˜121° C.) and 300° F. (˜149° C.). However, at a temperature of 200° F. (˜93° C.), these dissolution rates were too slow to be useful.

To achieve faster dissolution rates for these polymers without compromising the additional functional features mentioned above including (a) ease of molding, (b) crush strength, (c) sealing effectiveness, (d) swelling resistance, and (e) being easily dissolved by acidic treatment fluids, these polymers can be blended with water soluble polyether polymers. Polyethers useful for this purpose preferably have weight average molecular weights of 100,000 to 5,000,000, more typically, 200,000 to 1,000,000. In addition, such blends will typically contain at least 5 wt. % but no more than 40 wt. % of these water soluble polyethers. Preferably, such blends contain ≦25 wt. %, ≦20 wt. %, ≦15 wt. %, or even ≦10 wt. %, of these water soluble polyethers.

For example, we found that by blending the above molding grade PLA polymer and 10 wt. % of a fully water soluble polyether polymer having a molecular weight of 200,000 Daltons, the dissolution rate exhibited by this polymer under the highly acidic pH conditions associated with acidizing treatments can be increased, at least slightly, at 200° F. (˜93° C.) and 250° F. (˜121° C.).

### EXAMPLES

In order to more thoroughly describe this invention, the following working examples are provided.

In these working examples, ball sealers measuring ⅞ inch (˜22 mm) in diameter were made by a conventional injection molding machine. A variety of different commercially-available slowly water soluble polymers were used for this purpose. Those that were received from the manufacturer in the form of pellets were used as is, i.e., they were fed to the injection molding machine as received. Those that were received from the manufacturer in the form of powders were pelletized in a conventional pelletizing machine first.

### Dissolution Rates

The dissolution rates of a variety of different ball sealers produced as indicated above at various different simulated downhole conditions of temperature and pH where then determined by the following analytical test.

For each polymer tested, approximately 50-100 ⅞ inch (˜22 mm) diameter spherical ball sealers were made in the manner indicated above. Each was then placed in a separate sealed test vessel, which was also filled with the simulated aqueous treatment fluid being tested. Three different simulated aqueous treatment fluids were used, 2% KCl (pH ˜7), 15% HCl (pH ˜−0.65) and 0.04% NaOH (pH ˜11).

All of the test vessels used in a particular test were then placed in an oven which had been pre-heated to the temperature of the test, where they were allowed to remain for periods of time ranging between 15 minutes and 26 hours. Approximately every 15 to 30 minutes or so, one test vessel was removed from the oven. After cooling to room temperature, the vessel was opened and the ball sealer therein removed and allowed to dry. The weight of the dried ball sealer so obtained was then determined using an analytical balance with a precision of 0.00001 g. This weight was then compared to the dry weight of the same sample before being placed into the test vessel to determine the amount of the ball sealer that had dissolved under the particular conditions of time, temperature and pH conditions of the test.

The time it took for the polymer being tested to lose 35% of its mass through dissolution, as determined by the above analytical test, was taken as an indication of its dissolution rate at the particular temperature and pH of the test. 35% was selected as an arbitrary yet safe condition to use for determining dissolution rate, because a sphere having a diameter of ⅞ inch (˜22 mm) would need to lose about 50% of its volume to fall through a simulated perforation comprising a 0.42 inch (˜11 mm) diameter circular opening.

### Example 1

### PVA System—Low Temperature

A commercially available PVOH polymer exhibiting a DH (degree of hydrolysis) of 70-75 and a viscosity of 4.2-5.0 mPa s when measured in a 4% aqueous solution at 20° C. according to DIN 53015 was tested for dissolution rate at low temperatures ranging from 75° F. (˜24° C.) to 200° F. (˜93° C.) at alkaline (pH ˜11), neutral (PH ˜7) and acidic (PH ˜−0.65) conditions. The results obtained are set forth in the following Table 1:

TABLE 1
Example 1--Dissolution Rates, hours

| | pH Conditions | | |
|---|---|---|---|
| Temp, ° F. | Alkaline | Neutral | Acidic |
| 75 | 19 | 23 | 13 |
| 100 | 13 | 18 | 6 |
| 150 | 6 | 8 | 3 |
| 200 | 3 | 6 | 2 |

As can be seen from this table, these ball sealers exhibited useful dissolution rates ranging from 2 to 24 hours under all conditions tested. This suggests that ball sealers made from this particular polymer could be used to process any subterranean formation at temperatures ranging from 75° F. (˜24° C.) to 200° F. (˜93° C.), regardless of pH.

### Example 2

### PVOH System—High Temperature—Neutral and Alkaline Conditions

Example 1 was repeated, except that (a) the particular polymer used was a commercially available molding grade PVOH polymer (vinyl alcohol polymer) having a melting point of 200° C. to 240° C., a melt flow index (MFI) at 220° C. of 10-15 g/10 minute and a viscosity at 220° C. of 150-1500 Pa-sec, (b) the temperature of the test ranged from 200° F. (˜93° C.) to 300° F. (˜149° C.), and (c) acidic conditions were not tested. The results obtained are set forth in the following Table 2:

TABLE 2
Example 2--Dissolution Rates, hours

| | pH Conditions | | |
|---|---|---|---|
| Temp, ° F. | Alkaline | Neutral | Acidic |
| 200 | 4 | 5 | NA |
| 250 | 4 | 4 | NA |
| 300 | 2 | 2 | NA |

As can be seen from this table, these ball sealers exhibited useful dissolution rates ranging from 2 to 5 hours under neutral and alkaline conditions tested. This suggests that ball sealers made from this particular polymer could be used to process subterranean formations at these temperatures, whether at neutral or alkaline pH.

### Example 3

### EVOH System—High Temperature—Neutral and Alkaline Conditions

Example 1 was repeated, except that (a) the particular polymer used was a commercially available molding grade EVOH polymer (ethylene vinyl alcohol copolymer) which contained 24-48 mol % ethylene and had a degree of hydrolysis of 98 to 99%, (b) the temperature of the test ranged from 200° F. (˜93° C.) to 300° F. (˜149° C.), and (c) acidic conditions were not tested. The results obtained are set forth in the following Table 3:

TABLE 3
Example 3--Dissolution Rates, hours

| | pH Conditions | | |
|---|---|---|---|
| Temp, ° F. | Alkaline | Neutral | Acidic |
| 200 | 4 | 5 | N/A |
| 250 | 4 | 4 | N/A |
| 300 | 2 | 2 | N/A |

As can be seen from this table, these ball sealers exhibited useful dissolution rates ranging from 2 to 5 hours under neutral and alkaline conditions tested. This suggests that ball sealers made from this particular polymer could be used to process subterranean formations at these temperatures, whether at neutral or alkaline pH.

### Example 4

### PVOH/EVOH Blend—Low Temperature—Neutral and Alkaline Conditions

Example 1 was repeated, except that the particular polymer used was a blend of 90 wt. % of the PVOH polymer of Example 1 and 10 wt. % of the EVOH polymer of Example 2. The results obtained are set forth in the following Table 4:

TABLE 4
Example 4--Dissolution Rates, hours

| | pH Conditions | | |
|---|---|---|---|
| Temp, ° F. | Alkaline | Neutral | Acidic |
| 75 | 22 | >24 | 14 |
| 100 | 20 | 18 | 7 |
| 150 | 18 | 15 | 4 |
| 200 | 3 | 6 | — |

As can be seen from this table, except for neutral conditions at 75° F. (˜24° C.) and acidic conditions at 200° F. (˜93° C.), these ball sealers exhibited useful dissolution rates ranging from 3 to 22 hours at alkaline, neutral and highly acidic pH's. This suggests that, except for these two sets of conditions, ball sealers made from this particular polymer blend could be used to process subterranean formations at these relatively low temperatures, regardless of pH.

### Example 5

### PVOH/EVOH Blend—Medium Temperature—Neutral and Alkaline Conditions

Example 1 was repeated, except that (a) the particular polymer used was a blend of 60 wt. % of the PVOH polymer of Example 1 and 40 wt. % of the EVOH polymer of Example 3 and (b) the temperature range of the test was 150° F. (˜66° C.) to 250° F. (˜121° C.). The results obtained are set forth in the following Table 5:

TABLE 5
Example 5--Dissolution Rates, hours

| | pH Conditions | | |
|---|---|---|---|
| Temp, ° F. | Alkaline | Neutral | Acidic |
| 150 | >24 | >24 | 3 |
| 175 | 22 | >24 | — |
| 200 | 4 | 5 | 2 |
| 250 | 3 | 3 | — |

As can be seen from this table, in alkaline and neutral conditions at 150° F. (˜66° C.) and 175° F. (˜79° C.), the dissolution rates exhibited by this blend was either very slow (22 hours) or too slow to be practical (>24 hours). However, in alkaline and neutral conditions at the higher end of this temperature range, i.e., at 200° F. (˜93° C.) as well as 250° F. (˜121° C.), as well as in acidic conditions from 150° F. (˜66° C.) to 200° F. (˜93° C.), the dissolution rates exhibited by this blend were in a relatively narrow band of about 2 to 5 hours. This suggests that ball sealers made from this particular polymer blend could be effectively used in treating subterranean formations in alkaline and neutral conditions at temperatures of >175° F. (˜79° C.) to 250° F. (˜121° C.) as well as in the highly acidic pH conditions associated with acidizing treatments at temperatures of 150° F. (˜66° C.) to 200° F. (˜93° C.).

### Example 6

### Blend of High DH PVOH and PLA —Medium Temperature

Example 5 was repeated, except that the particular polymer used was a blend of 60 wt. % of a commercially available vinyl alcohol/vinyl acetate copolymer (PVOH) having a degree of hydrolysis of 85% and 40 wt. % of a commercially available fully amorphous grade polylactic acid ester (PLA) polymer. The results obtained are set forth in the following Table 6:

TABLE 6
Example 6--Dissolution Rates, hours

| | pH Conditions | | |
|---|---|---|---|
| Temp, ° F. | Alkaline | Neutral | Acidic |
| 150 | 4 | 4 | 3 |
| 200 | 2 | 3 | 2 |
| 250 | 2 | 2 | 2 |

As can be seen from this table, these ball sealers exhibited useful dissolution rates ranging from 2 to 4 hours under alkaline, neutral and highly acidic pH conditions. This suggests that ball sealers made from this particular polymer could be used to process subterranean formations at these temperatures, regardless of pH.

### Example 7

### PLA —High Temperature-Acidic Conditions

A number of ⅞ inch (˜22 mm) diameter spherical ball sealers were made by injection molding in the manner indicated above from a commercially available molding grade polylactic acid ester polymers (PLA) having a relative viscosity of 2.5, a D-isomer content of 1.4%, a melt flow rate of 80 g/10 min at 210° C. and a melt flow rate of 38 g/10 min at 190° C.

After cooling to room temperature, the ball sealers so obtained were tested for dissolution rate in the manner indicated above at temperatures ranging from 200° F. (˜93° C.) to 300° F. (˜149° C.) under acidic (PH ˜−0.6) conditions. The results obtained are set forth in the following Table 7:

TABLE 7
Example 7--Dissolution Rates, hours

| Temp, ° F. | Dissolution Rate, hours |
|---|---|
| 200 | >24 |
| 250 | 8 |
| 300 | 4 |

As can be seen from this table, at a temperature of 200° F. (˜93° C.), the dissolution rate of these ball sealers was too slow for most applications. However, at 250° F. (˜121° C.) and 300° F. (˜149° C.), the dissolution rates ranged from 8 to 4 hours. This suggests that ball sealers made from this particular polymer could be used to process subterranean formations at higher temperatures, i.e., >200° F. (˜93° C.) to 300° F. (˜149° C.) or more, under the highly acidic conditions associated with acidizing treatments.

### Example 8

### Condensation Polyester—High Temperature-Acidic Conditions

Example 7 was repeated, except that the polymer used was a commercially available condensation polyester copolymer of hydroxybutyrate and hydroxyhexanoate. The results obtained are set forth in the following Table 8:

TABLE 8
Example 8--Dissolution Rates, hours

| Temp, ° F. | Dissolution Rate, hours |
|---|---|
| 200 | >24 |
| 250 | 8 |
| 300 | 4 |

As can be seen from this table, the results obtained were essentially identical to those obtained in Example 7. This suggests that, like the ball sealers of Example 7, the ball sealers of this Example 8 could also be used to process subterranean formations at higher temperatures, i.e., >200° F. (˜93° C.) to 300° F. (˜149° C.) or more, under the highly acidic conditions associated with acidizing treatments.

### Example 9

### PLA/PEO Blend—High Temperature-Acidic Conditions

Example 7 was repeated, except that the polymer used was a blend containing 90 wt. % of the molding grade polylactic acid ester polymers (PLA) of Example 7 and 10 wt. % of a commercially available fully water soluble polyether polymer having a molecular weight of 200,000 Daltons. The results obtained are set forth in the following Table 9:

TABLE 9
Example 9--Dissolution Rates, hours

| Temp, ° F. | Dissolution Rate, hours |
|---|---|
| 175 | >24 |
| 200 | >24 |
| 250 | 8 |

As can be seen from this table, at temperatures of 175° F. (˜79° C.) and 200° F. (˜93° C.), the dissolution rates were too slow to be useful. On the other hand, at 250° F. (˜121° C.), the dissolution rate was 8 hours. This suggests that the ball sealers of this Example 9 could be used to process subterranean formations at higher temperatures, e.g., >200° F. (˜93° C.) to 300° F. (˜149° C.) or more, under the highly acidic conditions associated with acidizing treatments.

### Mechanical Integrity—Dry

In addition to dissolution rate, all of the ball sealers obtained above were also tested for mechanical integrity when dry in the following manner.

A sample of the ball sealer to be tested was placed on the platen of a hydraulic press, after which the piston of the press was lowered to just make contact with the ball sealer. The press was then activated, whereby the ball sealer was subjected to a continuously increasing pressure. The pressure at which the ball sealer cracked and/or broke was taken as the crush strength of the ball sealer under dry conditions.

All ball sealers tested exhibited a compressive strength of at least 15,000 psi (˜103 megapascal) and as high as 19000 psi (130 megapascal).

### Mechanical Integrity—Hot/Wet

In addition to dissolution rate and mechanical integrity under dry conditions, the ball sealers obtained were also analyzed for mechanical integrity under wet conditions in the following manner:

The ball sealer to be tested was inserted into a cylindrical test cell having a 1.8″ inside diameter, the bottom of which defined a circular opening ⅜ inch (˜9.5 cm) in diameter. The ball sealer was placed in the test cell so that it was received by and rested on the circular hole in the bottom the test cell, after which the test cell was filled with an aqueous test liquid having a neutral pH (pH ˜7). A piston was then inserted into the test cell in such a way as to act on the aqueous test liquid in the test cell. The assembly so formed was then placed in an oven which had been pre-heated to the temperature of the test by means of a heating jacket. When the aqueous liquid inside the test cell reached the designated temperature, the platen was activated to ramp the pressure inside the test sell up to a predetermined pressure between 400 psi (˜2.76 megapascal) and 850 psi (˜5.86 megapascal). This pressure was maintained for 40 to 60 minutes, after which the test vessel was removed from the oven and the ball sealer removed from the tested vessel. The ball sealer was then visually inspected to determine the extent of its physical deformation as determined by measuring the length, if any, of the section of the ball sealer which had been forced (by extrusion) through the circular hole in the bottom of the test vessel. The length of this extrudate, if any, is a measure of the mechanical integrity of the ball sealer under the conditions of temperature, pH and pressure of the test.

The ball sealers tested were the ball sealers of the above Examples 1 and 3-9. The following Table 10 identifies the ball sealer being tested in each test by the above example numbers as well as the conditions of each test.

TABLE 10
Mechanical Integrity under Hot/Wet Conditions

| | | | Immersion Time, (min) | | |
|---|---|---|---|---|---|
| | | Target | before | | |
| Ball Sealer | Pressure | Temperature, | reaching | at Target | |
| Example No. | (psi) | ° F. | Target Temp | Temp | Total |
| 1 | 800 | 100 | 8 | 60 | 68 |
| 4 | 800 | 100 | 8 | 60 | 68 |
| 5 | 800 | 175 | 12 | 60 | 72 |
| 3 | 800 | 250 | 30 | 60 | 90 |
| 3 | 800 | 175 | 15 | 60 | 75 |
| 7 | 850 | 175 | 13 | 60 | 73 |
| 8 | 850 | 175 | 13 | 60 | 73 |
| 8 | 800 | 250 | 40 | 60 | 100 |
| 6 | 700 | 175 | 13 | 40 | 53 |
| 6 | 800 | 150 | 10 | 60 | 70 |
| 9 | 400 | 250 | 40 | 40 | 80 |

For all ball sealers tested, the amount of ball sealer deformation, as reflected by the length of the extrudate produced, was less than 1 mm. This indicates that these ball sealers resisted mechanical deformation under the conditions of temperature and pressure of each test. This, in turn, suggests that these ball sealers would form effective seals at the conditions of these tests. That is to say, this suggests that these ball sealers exhibited the necessary sealing efficiency to be commercially useful.

### Comparative Examples A-D

Four commercially available PEO (polyethylene oxide) polymers having molecular weights ranging from 200,000 to 1 million Daltons were used in an attempt to make ⅞ inch (˜22 mm) diameter spherical ball sealers using a conventional injection molding machine. However, it was not possible to reliably and repeatedly produce acceptable ball sealers for two reasons, both relating to polymer swelling.

Those polymers received from the manufacturer in the form of powders were first processed to convert them into pellets suitable for use in feeding a conventional injection molding machine. This proved to be difficult because of excessive swelling of the polymer passing out of the extrusion die. This phenomenon, which is known as “die swelling” or the “Barus Effect,” occurs because of the viscoelastic nature of the polymer and indicates that substantial internal stresses remain in the polymer pellets that are ultimately produced. As appreciated by skilled polymer chemists, this also means that producing high quality injection molded parts reliably and consistently would be difficult, because the internal stresses remaining in the polymer pellets would impede uniform flow and solidification of the polymer once inside the mold of the injection molding machine.

The ball sealers that were produced from these polymer also exhibited excessive swelling when placed is simulated aqueous treatment fluids. That is, rather than simply dissolving over time when contacted with these fluids, these ball sealers experienced significant swelling through absorption of the treatment fluid. This suggests that these ball sealers could not effectively seal well bore perforations, as they could easily become dislodged due to their excessive increase in size.

Although only a few embodiments of this invention have been described above, it should be appreciated that many modifications can be made without departing from the spirit and scope of the invention. All such modifications are intended to be included within the scope of this invention, which is to be limited only by the following claims.

1. A first system of ball sealers capable of operating at all different downhole conditions of temperature and pH level, other than conditions of high temperature and acidic pH, this first system comprising the combination of two or more ball sealers, wherein each ball sealer in this system is made from a first slowly water soluble polymer, a second slowly water soluble polymer, or a blend of these two slowly water soluble polymers, wherein the first slowly water soluble polymer comprises a molding grade vinyl alcohol/vinyl acetate copolymer (PVOH) having a degree of hydrolysis of ˜50% to 84%, and further wherein the second slowly water soluble polymer comprises a vinyl alcohol/vinyl acetate copolymer (PVOH) having a melting point of 200° C. to 240° C., a melt flow index (MFI) at 220° C. of 10-15 g/10 minute and a viscosity at 220° C. of 150-1500 Pa-sec.

2. The first system of claim 1, wherein the ball sealers are made from a blend of the first slowly water soluble polymer and the second slowly water soluble polymer.

3. The first system of claim 1, wherein the ball sealers in the first system are made from the first slowly water soluble polymer but not the second slowly water soluble polymer.

4. The first system of claim 1, wherein the ball sealers in the first system are made from the second slowly water soluble polymer but not the first slowly water soluble polymer.

5. The first system of claim 1, wherein the system includes ball sealers made in whole or in part from a vinyl alcohol/vinyl acetate copolymer (PVOH) having a degree of hydrolysis of about 70-75%.

6. A process for temporarily sealing perforations in a well bore penetrating a subterranean formation, the process comprising charging into the well bore the first system of ball sealers of claim 1.

7. A second system of ball sealers capable of operating at all different downhole conditions of temperature and pH level, other than conditions of high temperature and acidic pH, this second system comprising the combination of two or more ball sealers, wherein each ball sealer in this second system is made from a first slowly water soluble polymer, a second slowly water soluble polymer, or a blend of these two slowly water soluble polymers, wherein the first slowly water soluble polymer comprises a vinyl alcohol/vinyl acetate copolymer (PVOH) having a degree of hydrolysis of ˜50% to 84% and further wherein the second slowly water soluble polymer comprises a molding grade ethylene/vinyl alcohol copolymer (EVOH) containing 24-48 mol % ethylene and having a degree of hydrolysis of 85% to 99%.

8. The second system of claim 7, wherein the ball sealers are made from a blend of the first slowly water soluble polymer and the second slowly water soluble polymer.

9. The second system of claim 12, wherein the blend contains 5 to 50 wt. % of the second slowly water soluble polymer.

10. The second system of claim 7, wherein the ball sealers in the second system are made from the first slowly water soluble polymer but not the second slowly water soluble polymer.

11. The second system of claim 7, wherein the ball sealers in the second system are made from the second slowly water soluble polymer but not the first slowly water soluble polymer.

12. The second system of claim 7, wherein the system includes ball sealers made in whole or in part from a vinyl alcohol/vinyl acetate copolymer (PVOH) having a degree of hydrolysis of about 70-75%.

13. A process for temporarily sealing perforations in a well bore penetrating a subterranean formation, the process comprising charging into the well bore the second system of ball sealers of claim 7.

14. Ball sealers capable of operating at medium downhole temperatures regardless of pH, wherein these ball sealers are made from blends containing 40 to 90 wt. % of one or more vinyl alcohol/vinyl acetate copolymers (PVOH) having a degree of hydrolysis of 85% or more and 10 to 60 wt. % wt. % of one or more fully amorphous grade polylactic acid ester (PLA) polymers.

15. The ball sealers of claim 14, wherein the blend contains 55 to 65 wt. % of one or more vinyl alcohol/vinyl acetate copolymers (PVOH) having a degree of hydrolysis of 85% or more and 45 to 35 wt. % of one or more fully amorphous grade polylactic acid ester (PLA) polymers.

16. A process for temporarily sealing perforations in a well bore penetrating a subterranean formation, the process comprising charging into the well bore the ball sealers of claim 14.

17. The process of claim 16, wherein the blend contains 55 to 65 wt. % of one or more vinyl alcohol/vinyl acetate copolymers (PVOH) having a degree of hydrolysis of 85% or more and 45 to 35 wt. % wt. % of one or more fully amorphous grade polylactic acid ester (PLA) polymers.

18. Ball sealers capable of operating at high downhole temperatures and the highly acidic pH levels associated with acidizing treatments, wherein these ball sealers are made from at least one of
(a) a molding grade polylactic acid ester polymer (PLA), and
(b) a condensation polymer or copolymer of one or more hydroxy-substituted C₁-C₁₀ carboxylic acids,
wherein the ball sealers contain 5 to 25 wt. % of a water soluble polyether polymer having a weight average molecular weights of 100,000 to 5,000,000.

19. The ball sealers of claim 18, wherein the ball sealers are made from a condensation polymer or copolymer of hydroxybutyrate, hydroxyhexanoate or a mixture thereof.

20. A process for temporarily sealing perforations in a well bore penetrating a subterranean formation exhibiting highly acidic pH conditions as a result of an acidizing treatment and a “high” temperature of ˜200° F. to 350° F. or higher (˜93° C. to ˜177° C. or higher), the process comprising charging into the well bore ball sealers are made from at least one of
(a) a molding grade polylactic acid ester polymer (PLA), and
(b) a condensation polymer or copolymer of one or more hydroxy-substituted C₁-C₁₀ carboxylic acids.

21. The process of claim 20, wherein the ball sealers are made from a condensation polymer or copolymer of hydroxybutyrate, hydroxyhexanoate or a mixture thereof.

22. The process of claim 20, wherein the ball sealers contain 5 to 25 wt. % of a water soluble polyether polymer having a weight average molecular weights of 100,000 to 5,000,000.
